(19) United States
(12) Patent Application Publication
(10) Pub. No.: US 2025/0174415 A1
(43) Pub. Date: May 29, 2025

(54) Handheld Device

(71) Applicant: AAC Acoustic Technologies (Shanghai) Co., Ltd., Shanghai (CN)

(72) Inventors: Hongguang Li, Shanghai (CN); Hanliang Shen, Shanghai (CN); Yanwei Duan, Shanghai (CN)

(21) Appl. No.: 18/625,254

(22) Filed: Apr. 3, 2024

Related U.S. Application Data
(63) Continuation of application No. PCT/CN2023/134354, filed on Nov. 27, 2023.

(51) Int. Cl. H01H 3/12; H01H 3/00

(52) U.S. Cl. CPC H01H 3/12; H01H 2003/008

(57) ABSTRACT

The present invention provides a handheld device includes a housing having an opening, a button contained in the housing and partially extending out of the housing from the opening, a sensor connected to the button to detect pressing states of the button, a chip electrically connected to the sensor, a vibration motor disposed on a side of the sensor, and an elastic connector. A suspension structure composed of the button, the sensor, and the vibration motor is connected to the housing through the elastic connector. The handheld device of the present invention can provide a plurality of tactile feedbacks of different frequencies, different durations, and different vibration times in different scenarios. The design of the suspension structure can concentrate the tactile feedback in a button area, which allowing one button to be used for multiple purposes, making the handheld device can adapt to different scenarios and meet different needs.

### FIELD OF THE PRESENT INVENTION

The present invention relates to the field of handheld device, and more particularly, to a tactile feedback structure of the handheld device.

### DESCRIPTION OF RELATED ART

The button is a press control device. As a key device for controlling the functions of the product, the button is widely used in various categories of products. Traditional buttons need to be pressed down for a certain distance to make the built-in shrapnel to deform for produce reverse elastic force to provide tactile feedback. The button with this structure has a single tactile feel and cannot achieve rich tactile effects. To solve this pain point, a tactile solution using vibration caused by motor instead of physical buttons has appeared on the market. However, the vibration of such buttons is relatively scattered, and the vibration of tactile feedback cannot be concentrated in the button area. The practicality is greatly reduced, and the application in different scenarios is greatly limited.

Therefore, it is desired to provide a new handheld device which can overcome the above problems.

### SUMMARY

In view of the above, the embodiments of the present invention provide a new handheld device, the area of the vibration sense of the tactile feedback of the handheld device is concentrated, and types of vibration senses are diverse.

The present invention provides a handheld device includes a housing having an opening, a button contained in the housing and partially extending out of the housing from the opening, a sensor connected to the button to detect pressing states of the button, a chip electrically connected to the sensor, a vibration motor disposed on a side of the sensor away from the button, and an elastic connector. A suspension structure composed of the button, the sensor, and the vibration motor is connected to the housing through the elastic connector.

As an improvement, a surrounding wall of the housing forming the opening is spaced apart from the button.

As an improvement, a number of the elastic connectors is two, and one end of each elastic connector is connected to the vibration motor, and the other end of each elastic connector is fixed to the housing.

As an improvement, the handheld device further includes a connecting block disposed between the vibration motor and the elastic connector, and the elastic connector is connected and fixed to the vibration motor through the connecting block.

As an improvement, the connecting block is a plastic block or a metal block.

As an improvement, the connecting block is fixed to the elastic connector or/and the vibration motor by gluing or welding.

As an improvement, the elastic connector includes a first connecting portion partially connected to the connecting block and a second connecting portion bending and extending horizontally from the first connecting portion to connect to the housing, and the first connecting portion and the second connecting portion are both sheet-like structures.

As an improvement, the button includes an extension part with a size smaller than a size of the opening and a stopper part with a size larger than the size of the opening.

As an improvement, a vibration direction of the vibration motor is perpendicular to a pressing direction of the button.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a handheld device in accordance with one embodiment of the present invention.

FIG. 2 is an illustrative isometric view of partly members of the handheld device of FIG. 1.

FIG. 3 is an exploded view of partly members of the handheld device of FIG. 2.

FIG. 4 is an illustrative cross-sectional view of the handheld device taken along line A-A of FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

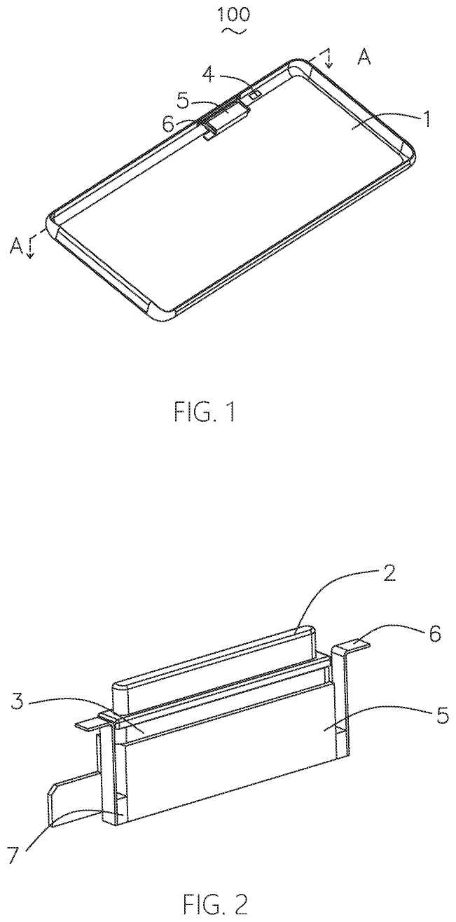

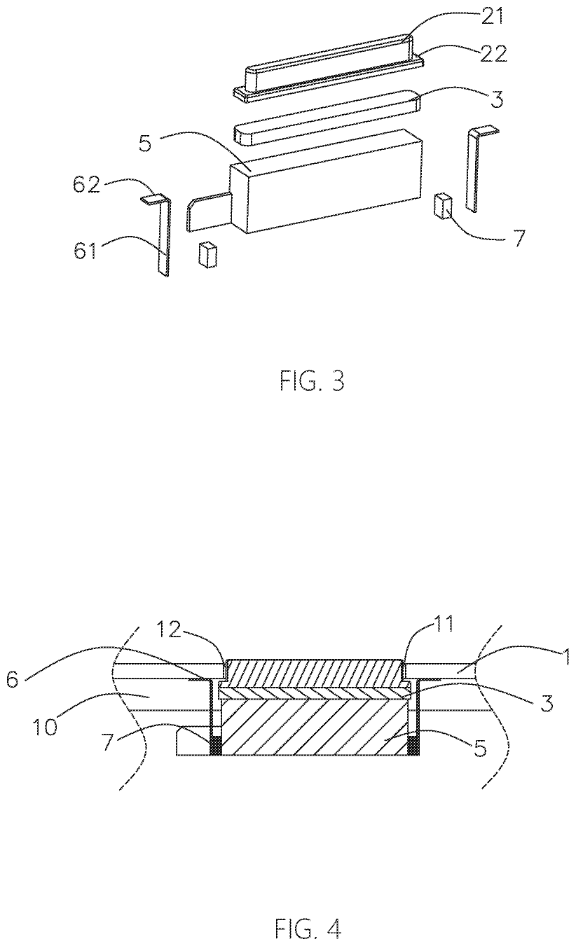

Referring to the FIGS. 1-4, the present invention provides one embodiment of a handheld device 100. The handheld device 100 includes a housing 1 having an opening 11, a button 2 contained in the housing 1 and partially extending out of the housing 1 from the opening 11, a sensor 3 located under the button 2, a chip 4 located in the housing 1 and electrically connected to the sensor 3, a vibration motor 5 disposed on a side of the sensor 3 away from the button 2, and an elastic connector 6.

A receiving space 10 is formed in the housing 1. The opening 11 is disposed on a sidewall of the housing 1 and is communicated with the receiving space 10. The housing 1 includes a surrounding wall 12 surrounding and forming the opening 11.

Part of the button 2 is received in the receiving space 10, and part of the button 2 extends out of the housing 1 from the opening 11. The button 2 includes an extension part 21 with a size smaller than a size of the opening 11 and a stopper part 22 with a size larger than the size of the opening 11. The extension part 21 extends out of the housing 1 through the opening 11. The stopper part 22 limits a length of the extension part 21 extending out of the housing 1. A height of the extension part 21 is greater than a height of the stopper part 22. A shape of the extension part 21 matches a shape of the opening 11, and the extension part 21 is spaced apart from the surrounding wall 12 forming the opening 11, that is, the extension part 21 of the button 2 does not contact with the housing 1, so that the button 2, the sensor 3, and the vibration motor 5 form a suspension structure suspended in the receiving space 10 of the housing 1.

The sensor 3 may be a pressure sensor, and the sensor 3 is connected to the button 2 to detect pressing states of the button 2. The pressing states includes: whether there is a pressing behavior, and the intensity of the pressing, and the duration of the pressing.

The chip 4 is electrically connected to the sensor 3 and the vibration motor 5. When the button 2 is pressed, the sensor 3 recognizes the pressing information, which including the duration and intensity of the pressing, and then sends an electrical signal to the chip 4. The chip 4 then sends a corresponding predetermined vibration signal to the vibration motor 5 based on the received electrical signal of pressing information. The predetermined vibration signal is given to the vibration motor 5 to cause the vibration motor 5 to vibrate to provide tactile feedback.

A vibration direction of the vibration motor 5 is perpendicular to a pressing direction of the button 2, or the vibration direction of the vibration motor 5 is parallel to the pressing direction of the button 2. Preferably, the vibration direction of the vibration motor 5 is perpendicular to a pressing direction of the button 2.

The suspension structure composed of the button 2, the sensor 3, and the vibration motor 5 is connected to the housing 1 through the elastic connector 6. A number of the elastic connectors 6 is two, and one end of each elastic connector 6 is connected to the vibration motor 5, and the other end of each elastic connector 6 is fixed to the housing 1. Specifically, each elastic connector 6 includes a first connecting portion 61 partially connected to the vibration motor 5 and a second connecting portion 62 bending and extending horizontally from the first connecting portion 61 to connect to the housing 1. The first connecting portion 61 and the second connecting portion 62 are both sheet-like structures. Due to the flexible effect of the elastic connectors 6, an inertial force of vibration is concentrated on the suspension structure, so that people can feel a local concentrated vibration when touching the button 2.

The elastic connector 6 can be directly connected to the vibration motor 5, or can be indirectly fixed to the vibration motor 5. Optionally, in present embodiment, the handheld device 100 further includes a connecting block 7 disposed between the vibration motor 5 and the elastic connector 6. The connecting block 7 is fixed to an end of the first connecting portion 61 of the elastic connector 6. And the elastic connector 6 is connected and fixed to the vibration motor 5 through the connecting block 7. The connecting block 7 is a plastic block or a metal block, or is made of other harder materials. The connecting block 7 is fixed to the elastic connector 6 or/and the vibration motor 5 by gluing or welding.

For example, if the connecting block 7 is made of plastic material, the connecting block 7 is fixed to the elastic connector 6 or the vibration motor 5 by gluing. If the connecting block 7 is made of metal, the connecting block 7 is fixed to the elastic connector 6 or the vibration motor 5 by gluing or welding.

In the present invention, due to the vibration motor 5, the sensor 3 and the button 2 connected as a whole to form the suspension structure, the vibration motor 5 will bring the button 2 to vibrate together. Due to the suspension effect of the elastic connector 6 and the position of the suspension structure, which make the tactile effect generated by vibration concentrated in the button area, and the vibration sense can be concentrated. At the same time, changing the predetermined vibration signal can produce different tactile effects on the button 2, which can be applied to different applications scenarios, bring richer application effects, and the practicality of the handheld device 100 is greatly enhanced.

Comparing with the related art, the present invention provides a handheld device including a housing having an opening, a button contained in the housing and partially extending out of the housing from the opening, a sensor connected to the button to detect pressing states of the button, a chip electrically connected to the sensor, a vibration motor disposed on a side of the sensor away from the button, and an elastic connector. A suspension structure composed of the button, the sensor, and the vibration motor is connected to the housing through the elastic connector. In the handheld device of the present invention, the button structure can create rich tactile effects. The handheld device can provide a plurality of tactile feedbacks of different frequencies, different durations, and different vibration times in different scenarios. The design of the suspension structure composed of vibration motor, the sensor and the button can concentrate the tactile feedback in the button area, preserving the function of the physical buttons and making the application of the buttons more diversified.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A handheld device, comprising:
a housing having an opening;
a button contained in the housing and partially extending out of the housing from the opening;
a sensor connected to the button to detect pressing states of the button;
a chip electrically connected to the sensor;
a vibration motor disposed on a side of the sensor away from the button; and
an elastic connector;
wherein a suspension structure composed of the button, the sensor, and the vibration motor is connected to the housing through the elastic connector.

2. The handheld device as described in claim 1, wherein a surrounding wall of the housing forming the opening is spaced apart from the button.

3. The handheld device as described in claim 2, wherein a number of the elastic connectors is two, and one end of each elastic connector is connected to the vibration motor, and the other end of each elastic connector is fixed to the housing.

4. The handheld device as described in claim 3, wherein the handheld device further comprises a connecting block disposed between the vibration motor and the elastic connector, and the elastic connector is connected and fixed to the vibration motor through the connecting block.

5. The handheld device as described in claim 4, wherein the connecting block is a plastic block or a metal block.

6. The handheld device as described in claim 4, wherein the connecting block is fixed to the elastic connector or/and the vibration motor by gluing or welding.

7. The handheld device as described in claim 4, wherein the elastic connector comprises a first connecting portion partially connected to the connecting block and a second connecting portion bending and extending horizontally from the first connecting portion to connect to the housing, and the first connecting portion and the second connecting portion are both sheet-like structures.

8. The handheld device as described in claim 2, wherein the button comprises an extension part with a size smaller than a size of the opening and a stopper part with a size larger than the size of the opening.

9. The handheld device as described in claim 1, wherein a vibration direction of the vibration motor is perpendicular to a pressing direction of the button.
